(19) United States
(12) Patent Application Publication
(10) Pub. No.: US 2026/0054172 A1
(43) Pub. Date: Feb. 26, 2026

(54) VIRTUAL PROP CONTROL METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Minke ZHOU, Shenzhen (CN)

(21) Appl. No.: 19/372,775

(22) Filed: Oct. 29, 2025

Related U.S. Application Data
(63) Continuation of application No. PCT/CN2024/137715, filed on Dec. 9, 2024.

(30) Foreign Application Priority Data
Jan. 18, 2024 (CN) 202410077656.7

(51) Int. Cl. A63F 13/53; A63F 13/44; A63F 13/837

(52) U.S. Cl. CPC A63F 13/53; A63F 13/44; A63F 13/837

(57) ABSTRACT

A virtual prop control method includes displaying a scene interface of a virtual scene that includes a first virtual object equipped with a virtual shooting prop; receiving a shooting charge operation triggered for the virtual shooting prop, the shooting charge operation having N charge stages, and N being an integer greater than or equal to 2; applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and applying, in response to the shooting charge operation being converted into the shooting operation in a second operation stage, the buffs corresponding to the N charge stages to the virtual projectile.

### CROSS-REFERENCES TO RELATED APPLICATIONS

This application is a continuation application of PCT Patent Application No. PCT/CN2024/137715, filed on Dec. 9, 2024, which claims priority to Chinese Patent Application No. 2024100776567, filed on Jan. 18, 2024, all of which is incorporated herein by reference in their entirety.

### FIELD OF THE TECHNOLOGY

The present disclosure relates to the technical field of gaming, and in particular, to a virtual prop control technology.

### BACKGROUND OF THE DISCLOSURE

A game application based on a virtual scene usually provides a virtual prop. A user may control a virtual object to engage in a battle within the virtual scene by using the virtual prop.

In related technologies, a user may touch and hold a button to control a virtual prop to perform charging, and then release the button, so that a virtual object implements a charge attack operation by using the virtual prop in a virtual scene, thereby achieving a damage effect stronger than an ordinary attack.

However, in the above scheme, an adjustment space of the virtual prop in a charge stage is limited, and only a single charging effect can be generated. This is not conducive to expanding the application mechanism of the virtual prop and affects an interaction between the user and the virtual scene.

### SUMMARY

One aspect of the present disclosure provides a virtual prop control method, performed by a computer device. The method includes: displaying a scene interface of a virtual scene, the virtual scene including a first virtual object, the first virtual object being equipped with a virtual shooting prop; receiving a shooting charge operation triggered for the virtual shooting prop, the shooting charge operation having N charge stages, and N being an integer greater than or equal to 2; applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and applying, in response to the shooting charge operation being converted into the shooting operation in a second operation stage, the buffs corresponding to the N charge stages to the virtual projectile, the second operation stage being after the N charge stages.

Another aspect of the present disclosure provides a computer device. The computer device includes one or more processors and a memory containing at least one computer instruction that, when being executed, causes the one or more processors to perform: displaying a scene interface of a virtual scene, the virtual scene including a first virtual object, the first virtual object being equipped with a virtual shooting prop; receiving a shooting charge operation triggered for the virtual shooting prop, the shooting charge operation having N charge stages, and N being an integer greater than or equal to 2; applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and applying, in response to the shooting charge operation being converted into the shooting operation in a second operation stage, the buffs corresponding to the N charge stages to the virtual projectile, the second operation stage being after the N charge stages.

Another aspect of the present disclosure provides a non-transitory computer readable storage medium containing at least one computer instruction that, when being executed, causes at least one processor to perform: displaying a scene interface of a virtual scene, the virtual scene including a first virtual object, the first virtual object being equipped with a virtual shooting prop; receiving a shooting charge operation triggered for the virtual shooting prop, the shooting charge operation having N charge stages, and N being an integer greater than or equal to 2; applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and applying, in response to the shooting charge operation being converted into the shooting operation in a second operation stage, the buffs corresponding to the N charge stages to the virtual projectile, the second operation stage being after the N charge stages.

### BRIEF DESCRIPTION OF THE DRAWINGS

To more clearly describe technical solutions in embodiments of the present disclosure, drawings required for the description of the embodiments are briefly described below. Clearly, the drawings in the following description show only some embodiments of the present disclosure, and a person of ordinary skill in the art may derive other drawings from these drawings without making creative efforts.

FIG. 1 is a structural block diagram of a computer system according to an exemplary embodiment of the present disclosure.

FIG. 2 is a flowchart of a virtual prop control method according to an exemplary embodiment of the present disclosure.

FIG. 3 is a flowchart of a virtual prop control method according to an exemplary embodiment of the present disclosure.

FIG. 4 is a flowchart of a virtual prop control method according to an exemplary embodiment of the present disclosure.

FIG. 5 is an interface diagram of shooting prop selection according to an exemplary embodiment of the present disclosure.

FIG. 6 is an interface diagram of a virtual arch in an uncharged state according to an exemplary embodiment of the present disclosure.

FIG. 7 is an interface diagram of the virtual arch in a first charge stage according to an exemplary embodiment of the present disclosure.

FIG. 8 is an interface diagram of the virtual arch in a second charge stage according to an exemplary embodiment of the present disclosure.

FIG. 9 is an interface diagram of the virtual arch in a third charge stage according to an exemplary embodiment of the present disclosure.

FIG. 10 is an interface diagram in which the virtual arch performs firing after undergoing the first two charge stages according to an exemplary embodiment of the present disclosure.

FIG. 11 is a flowchart of an implementation of multi-stage charge according to an exemplary embodiment of the present disclosure.

FIG. 12 is a schematic diagram of timing management introduced based on button recording according to an exemplary embodiment of the present disclosure.

FIG. 13 is a schematic diagram of a prop damage amplification curve according to an exemplary embodiment of the present disclosure.

FIG. 14 is a schematic diagram of damage amplification introduced to a charging mechanism according to an exemplary embodiment of the present disclosure.

FIG. 15 is a schematic diagram of bullet radius amplification and flight speed increase in the charging mechanism according to an exemplary embodiment of the present disclosure.

FIG. 16 is a schematic diagram of a bullet radius amplification curve in the charging mechanism according to an exemplary embodiment of the present disclosure.

FIG. 17 is a schematic diagram of a collision box according to an exemplary embodiment of the present disclosure.

FIG. 18 is a schematic diagram of arch and arrow charging and corresponding effects according to an exemplary embodiment of the present disclosure.

FIG. 19 is a block diagram of a virtual prop control apparatus according to an exemplary embodiment of the present disclosure.

FIG. 20 is a structural block diagram of a computer device according to an exemplary embodiment of the present disclosure.

The drawings herein, which are incorporated into the specification and constitute a part of the specification, illustrate embodiments that conform to the present disclosure and are used together with the specification to explain the principles of the present disclosure.

### DESCRIPTION OF EMBODIMENTS

To make objectives, technical solutions, and advantages of the present disclosure clearer, implementations of the present disclosure are further described in detail below with reference to drawings.

Exemplary embodiments are described in detail herein, and examples of the exemplary embodiments are shown in the drawings. When the following description involves the drawings, unless otherwise indicated, the same numerals in different drawings represent the same or similar elements. The implementations described in the following exemplary embodiments do not represent all implementations consistent with the present disclosure. On the contrary, the implementations are merely examples of apparatuses and methods that are described in detail in the appended claims and that are consistent with some aspects of the present disclosure.

Terms used in the present disclosure are for the purpose of describing specific embodiments only and are not intended to limit the present disclosure. The singular forms such as “a”, “the”, and “said” used in the present disclosure and the appended claims are intended to include plural forms as well, unless the context clearly indicates otherwise. The term “and/or” used herein indicates and includes any or all possible combinations of one or more associated listed items.

User information (including but not limited to user equipment information and user personal information) and data (including but not limited to data for analysis, stored data, and displayed data) involved in the present disclosure both are information and data authorized by a user or fully authorized by all parties, and collection, use, and processing of related data need to comply with relevant laws, regulations, and standards of relevant countries and regions. For example, attack operations and other object behaviors involved in the present disclosure are all obtained under full authorization.

Although the terms such as “first” and “second” may be used in the present disclosure to describe various information, the information cannot be limited to these terms. These terms are merely configured for distinguishing between information of the same type. For example, without departing from the scope of the present disclosure, a first parameter may also be referred to as a second parameter, and similarly, the second parameter may also be referred to as the first parameter. Depending on the context, for example, the word “if” used herein may be interpreted as “while”, “when”, or “in response to determining that”.

For convenience of understanding, some terms involved in the present disclosure are described below.

### 1) Virtual Scene

It is a virtualized scene displayed (or provided) when an application is run on a terminal. The virtual scene may be a simulated environment scene for the real world, or may be a semi-simulated and semi-fictitious environment scene, or may be a purely fictitious environment scene. The virtual scene may be any one of a two-dimensional virtual scene, a 2.5-dimensional virtual scene, or a three-dimensional virtual scene. The following embodiments are described by using an example in which the virtual scene is a three-dimensional virtual scene, but no limitation is imposed. In some embodiments, the virtual scene may be further configured for supporting virtual scene battles between at least two virtual characters. In some embodiments, the virtual scene may be further configured for supporting at least two virtual characters to battle with each other by using a virtual prop. In some embodiments, the virtual scene may be further configured for supporting at least two virtual characters to battle with each other by using a virtual prop within a target range, the target range becoming smaller over time in the virtual scene.

A virtual scene is generally generated by an application in a computer device such as a terminal, and is displayed through hardware (such as a screen) in the terminal. The terminal may be a mobile terminal such as a smartphone, a tablet computer, or an ebook reader. Alternatively, the terminal may be a personal computer device such as a notebook computer or a fixed-type computer.

### 2) Virtual Object

It is a movable object in a virtual scene. The movable object may be at least one of a virtual person, a virtual character, a virtual animal, or a virtual carrier. In some embodiments, when the virtual scene is a three-dimensional virtual scene, the virtual object is a three-dimensional model created based on a skeletal animation technology. Each virtual object has a shape, a volume, and an orientation in the three-dimensional virtual scene, and occupies some space in the three-dimensional virtual scene.

### 3) Shooting Game

It includes but is not limited to games that use virtual props for attack such as a first-person shooting (FPS) game and a third-person shooting (TPS) game.

In a shooting game, at least two virtual objects may perform a single-round battle mode in a virtual environment. For example, a virtual object may evade damage initiated by another virtual object and a danger (such as a poison circle and a marshland) existing in the virtual environment, to achieve survival in the virtual environment. When a life value of a virtual object in the virtual environment is zero, the life of the virtual object in the virtual environment ends, and a virtual object that finally survives in the virtual environment is a winner. In some embodiments, the battle uses a moment at which the first client joins the battle as a start moment and a moment at which the last client exits the battle as an end moment, and each client may control one or more virtual objects in a virtual environment. In some embodiments, an arena mode of the battle may include a one-person battle mode, a double-group battle mode, or a multi-group battle mode. The battle mode is not limited in the embodiments of the present disclosure.

### 4) Charging

It is a state of a virtual prop before an attack. Some virtual props can launch an attack only after a player holds a corresponding control button for a period of time. In a period of time in which the player holds a control button, a state of the virtual prop is a charging state. For example, the virtual prop is a shooting prop. A particular shooting prop can be fired only after a player holds a firing button for a period of time. In the period of time in which the player holds the firing button, the shooting prop is in a charging state.

### 5) Mobile End

It generally refers to a game client that is run on a handheld portable game device such as a mobile phone, but is not limited thereto.

### 6) User Interface (UI)

It is a medium through which a user interacts with a computer program, a device, or an operating system. Design of a UI involves aspects such as a layout, a color, an icon, and a font, to ensure that the user can easily understand and operate software or a device.

The present disclosure provides a virtual prop control method and apparatus, a device, a storage medium, and a program product, which can extend an adjustment space of a virtual prop in a charge stage, which enriches a charging effect of the virtual prop, thereby facilitating extension of an application mechanism of the virtual prop, and enriching an interaction effect between a user and a virtual scene.

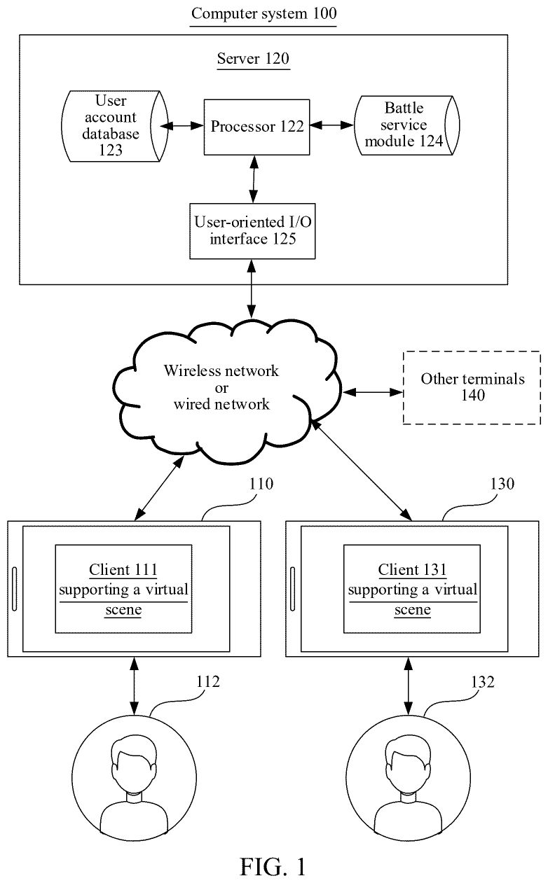

FIG. 1 is a structural block diagram of a computer system according to an exemplary embodiment of the present disclosure. A computer system 100 includes a first terminal 110, a server 120, and a second terminal 130.

A client 111 supporting a virtual scene is installed and run in the first terminal 110. The client 111 may be a multiplayer online battle program. When the first terminal runs the client 111, a user interface of the client 111 is displayed on a screen of the first terminal 110. The client 111 may include but is not limited to any one of a simulation program, a virtual reality (VR) application, an augmented reality (AR) program, a three-dimensional map program, a VR game, an AR game, a multiplayer online battle arena (MOBA) game, or a simulation game (SLG). In this embodiment, an example in which the client 111 is an SLG is used for description. The first terminal 110 is a terminal used by a first user 112. The first user 112 uses the first terminal 110 to control a first virtual object in a virtual scene to perform activities. The first virtual object may be referred to as a virtual object of the first user 112. The activities of the first virtual object include but are not limited to at least one of moving, jumping, transferring, releasing skills, using props, adjusting body postures, crawling, walking, running, riding, flying, driving, picking, shooting, attacking, or throwing. Exemplarily, the first virtual object may be a simulated character or a cartoon character, for example.

A client 131 supporting a virtual scene is installed and run in the second terminal 130. The client 131 may be a multiplayer online battle program. When the second terminal 130 runs the client 131, a user interface of the client 131 is displayed on a screen of the second terminal 130. The client may include but is not limited to a simulation program, a battle royale shooting game, a VR application, an AR program, a three-dimensional map program, a VR game, an AR game, an FPS, a TPS, a MOBA, or an SLG. In this embodiment, an example in which the client 131 is an SLG is used for description. The second terminal 130 is a terminal used by a second user 132. The second user 132 uses the second terminal 130 to control a second virtual object in a virtual scene to perform activities. The second virtual object may be referred to as a virtual object of the second user 132. Exemplarily, the second virtual object may be a simulated character or a cartoon character, for example.

In some embodiments, the first virtual object and the second virtual object are in the same virtual scene. In some embodiments, the first virtual object and the second virtual object may belong to the same camp, the same team, or the same organization. The first user 112 and the second user 132 and have a friend relationship or have a temporary communication permission. In some embodiments, the first virtual object and the second virtual object may belong to different camps, different teams, or different organizations, or have an enemy relationship.

In some embodiments, the clients installed on the first terminal 110 and the second terminal 130 are the same, or the clients installed on the two terminals are the same client on different operating system platforms (Android or IOS). The first terminal 110 may generally refer to one of a plurality of terminals, and the second terminal 130 may generally refer to another of the plurality of terminals. In this embodiment, only the first terminal 110 and the second terminal 130 are used as examples for description. A device type of the first terminal 110 and a device type of the second terminal 130 may be the same or different. The device type includes at least one of a smartphone, a tablet computer, an ebook reader, a moving picture experts group audio layer 3 (MP3) player, a moving picture experts group audio layer 4 (MP4) player, a laptop portable computer, or a desk computer.

FIG. 1 shows only two terminals. However, in a different embodiment, a plurality of other terminals 140 may be connected to the server 120 through a wireless or wired network. In some embodiments, one or more terminals 140 that correspond to a developer may exist. A development and editing platform for a client that supports a virtual scene is installed on the terminal 140. The developer may edit and update the client on the terminal 140, and transmit an updated client installation package to the server 120 through a wired or wireless network. The first terminal 110 and the second terminal 130 may download the client installation package from the server 120 to update the client.

The first terminal 110, the second terminal 130, and the other terminals 140 are connected to the server 120 through the wired or wireless network.

The server 120 includes at least one of one server, a plurality of servers, a cloud computing platform, or a virtualization center. The server 120 is configured to provide a backend service for the client that supports the virtual scene. In some embodiments, the server 120 is in charge of primary computing works, and the terminal is in charge of secondary computing works. Alternatively, the server 120 is in charge of the secondary computing works, and the terminal is in charge of the primary computing works. Alternatively, the server 120 and the terminal perform collaborative computing by using a distributed computing architecture.

In an exemplary example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts logged on the first terminal 110, the second terminal 130, and the other terminals 140, such as avatars of the user accounts, nicknames of the user accounts, fighting power indexes of the user accounts, and service areas of the user accounts. The battle service module 124 is configured to provide a plurality of battle rooms for users to battle, for example, a 1V1 battle room, a 3V3 battle room, and a 5V5 battle room. The user-oriented I/O interface 125 is configured to establish communication with the first terminal 110 and/or the second terminal 130 through a wireless network or a wired network for data exchange.

A method provided in subsequent embodiments of the present disclosure may be applied to at least one of the following scenarios: a VR application, a three-dimensional map program, a simulation program, a MOBA game, an SLG, or a multiplayer gunfight survival game, but the application is not limited thereto. The following embodiments are described by using application in a game as an example.

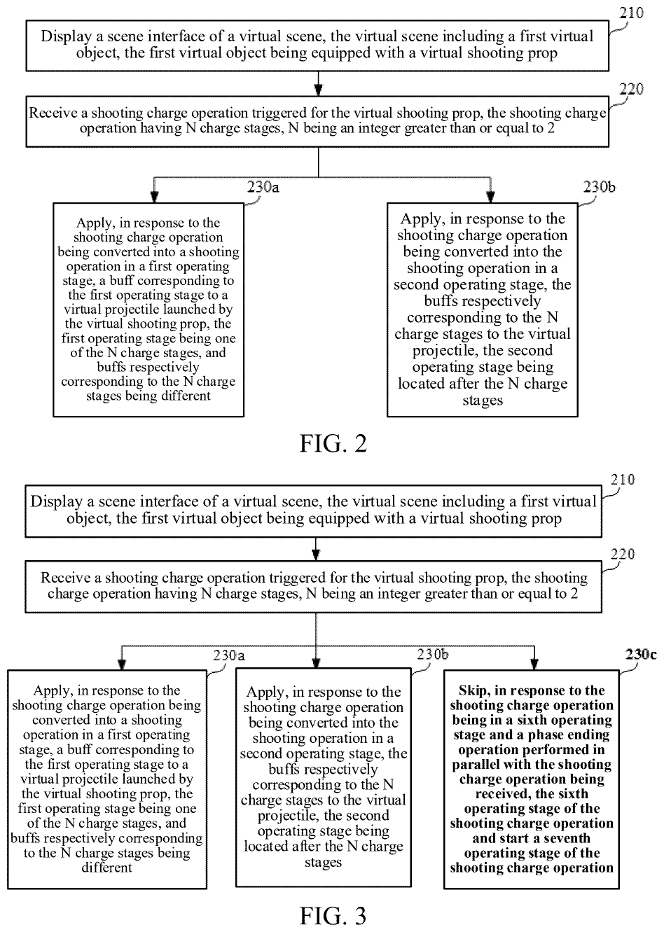

FIG. 2 is a flowchart of a virtual prop control method according to an exemplary embodiment of the present disclosure. The method may be performed by a computer device. The computer device may be the first terminal 110 or the second terminal 130 in the system shown in FIG. 1. Alternatively, the computer device may be the server 120 in the system shown in FIG. 1. Alternatively, the computer device may include the first terminal 110 or the second terminal 130 and the server 120 in the system shown in FIG. 1. The method includes the following operations:

Operation 210: Display a scene interface of a virtual scene, the virtual scene including a first virtual object, the first virtual object being equipped with a virtual shooting prop.

In some embodiments, the computer device may display a first virtual object and at least one another virtual object in the scene interface of the virtual scene.

Exemplarily, the first virtual object is a virtual object controlled by a user account logged on the client, and the virtual scene is configured for providing an environment for virtual tactical competition between different virtual objects.

Exemplarily, the first virtual object and the another virtual object belong to different virtual camps. The virtual camp to which the another virtual object belongs and the virtual camp to which the first virtual object belongs may be in an enemy relationship, or may be in a mutual neutral relationship. This is not limited in the present disclosure. In an implementation, the foregoing two camps are in an enemy relationship, and the another virtual object may actively perform a virtual attack on the first virtual object. In another implementation, the foregoing two camps are in a neutral relationship. The another virtual object does not actively perform a virtual attack on the first virtual object, and when attacked by the first virtual object, the another virtual object performs a virtual attack on the first virtual object.

A control user corresponding to the first virtual object may control the first virtual object to initiate a virtual attack on the another virtual object.

Exemplarily, an implementation of the attack operation on the another virtual object includes but is not limited to at least one of the following: tapping, touching and holding, sliding, or rotating, for example, tapping/touching and holding a touch screen or a button, sliding a touch screen or a handle, or rotating a terminal or a handle.

For example, a manner in which the first virtual object performs a virtual attack includes, but is not limited to, at least one of launching a virtual projectile by using a virtual shooting prop, throwing a virtual throwing prop, waving a virtual rig, or releasing a virtual skill. A specific implementation in which the first virtual object performs a virtual attack on the another virtual object is not limited.

Correspondingly, a control user corresponding to the another virtual object may also control the another virtual object to initiate a virtual attack on the first virtual object.

In an exemplary embodiment, when the first virtual object is equipped with a virtual shooting prop, a manner in which the first virtual object performs a virtual attack may be launching a virtual projectile by using the virtual shooting prop to attack the another virtual object.

In some embodiments, the foregoing virtual shooting prop is a virtual shooting prop that is equipped with specified equipment and that is triggered to be released. In a virtual scene, by default, the first virtual object may have one or more virtual shooting props, and a user may selectively equip the first virtual object with one or more virtual shooting props.

Operation 220: Receive a shooting charge operation triggered for the virtual shooting prop, the shooting charge operation having N charge stages, N being an integer greater than or equal to 2.

In an exemplary embodiment, the virtual shooting prop is a virtual prop that needs charging before initiating shooting. Therefore, during use of the virtual shooting prop, a shooting charge operation needs to be triggered for the virtual shooting prop first. The shooting charge operation may also be understood as a use operation for the virtual shooting prop. To be specific, the user triggers the use operation for the virtual shooting prop, which means that the shooting charge operation is triggered for the virtual shooting prop, so that the virtual shooting prop enters a charging state. Exemplarily, the user may hold a use control corresponding to the virtual shooting prop in the interface, to trigger the shooting charge operation for the virtual shooting prop.

A whole process of the foregoing shooting charge operation may have N charge stages. When the shooting charge operation proceeds to different charge stages, different shooting buffs can be provided for the virtual shooting prop. A specific charge stage to which the shooting charge operation proceeds may be specifically defined by a duration of the shooting charge operation.

For example, the N charge stages are arranged in chronological order. During execution of the shooting charge operation by the user, as the duration of the shooting charge operation continuously increases, the shooting charge operation sequentially undergoes one or more charge stages of the N charge stages until the shooting charge operation is converted into a shooting operation. For example, when the user performs the shooting charge operation, within the 1^{st} second, the shooting charge operation is in the 1^{st} charge stage of the N charge stages, when the duration of the shooting charge operation reaches the 2^{nd} second, the shooting charge operation is in the 2^{nd} charge stage of the N charge stages, and so on. If the shooting charge operation is converted into the shooting operation within the 2^{nd} second, the shooting charge operation ends. Even if the subsequent 3^{rd} charge stage exists, the shooting charge operation does not undergo the 3^{rd} charge stage.

Operation 230a: Apply, in response to the shooting charge operation being converted into a shooting operation in a first operation stage, a buff corresponding to the first operation stage to a virtual projectile launched by the virtual shooting prop, the first operation stage being one of the N charge stages, and buffs respectively corresponding to the N charge stages being different.

The entire process of the shooting charge operation has at least two charge stages. Durations of the charge stages may be the same or different. Each charge stage in the process of the shooting charge operation corresponds to one or more buffs. Different charge stages correspond to different buffs.

That the shooting charge operation is converted into the shooting operation means stopping performing the shooting charge operation and controlling the virtual shooting prop to initiate shooting. In an exemplary embodiment, that the shooting charge operation is converted into the shooting operation may also be referred to as the shooting charge operation being released. Exemplarily, when the user implements the shooting charge operation by holding the use control corresponding to the virtual shooting prop, the user may stop holding the use control corresponding to the virtual shooting prop, to convert the shooting charge operation into the shooting operation, i.e., release the holding operation for the use control corresponding to the virtual shooting prop, to convert the shooting charge operation into the shooting operation.

In an exemplary embodiment, for a charge stage in which the foregoing shooting charge operation is converted into the shooting operation, an application in the virtual scene may apply a buff corresponding to the charge stage to the virtual projectile launched by the virtual shooting prop. In other words, when the shooting charge operation is converted into the shooting operation in different charge stages of the N charge stages, different buffs are applied to the virtual projectile launched by the virtual shooting prop.

For example, it is assumed that the N charge stages include a charge stage 1 (corresponding to the 1^{st} second) and a charge stage 2 (corresponding to the 2^{nd} second), a buff corresponding to the charge stage 1 is enhancing damage, and a buff corresponding to the charge stage 2 is a knockback effect. If the shooting charge operation is converted into the shooting operation within the 1^{st} second, the application in the virtual scene may apply the effect of increasing damage to the virtual projectile. If the shooting charge operation is converted into the shooting operation within the 2^{nd} second, the application in the virtual scene may apply the knockback effect to the virtual projectile (in this case, the effect of enhancing damage may not be applied).

Operation 230b: Apply, in response to the shooting charge operation being converted into the shooting operation in a second operation stage, the buffs respectively corresponding to the N charge stages to the virtual projectile, the second operation stage being after the N charge stages.

The second operation stage is an operation stage after all of the N charge stages are ended. To be specific, if the duration of the shooting charge operation is long enough to completely undergo all of the N charge stages, the shooting charge operation is converted into the shooting operation only after the N charge stages. In this case, all of the buffs respectively corresponding to the N charge stages are applied to the virtual projectile.

For example, the shooting charge operation includes a charge stage A and a charge stage B. The charge stage A and the charge stage B respectively correspond to different buffs. The buff corresponding to the charge stage A is that a blood volume of a hit object decreases by 50%, and the buff corresponding to the charge stage B is that the virtual projectile makes a sound effect during emission. A duration of the charge stage A is one second, and a duration of the charge stage B is three seconds. The charge stage B is after the charge stage A. It is assumed that an operation duration of the entire shooting charge operation is five seconds. In this case, the shooting charge operation is in the second operation stage, i.e., is after the charge stage B. In this case, the virtual shooting prop releases the virtual projectile. Buffs respectively corresponding to the charge stages A and B are carried on the virtual projectile. The virtual projectile makes a sound effect during emission. After the virtual shooting object hits a target object, a blood volume of the target object decreases by 50%.

In an exemplary embodiment, different buffs are set for the virtual projectile in different charge stages, and all buffs of all preceding charge stages are set for the virtual projectile after the last charge stage ends, so as to allow the user to select different types of buffs by controlling the duration of the shooting charge operation. This increases operation manners for the user to select different buffs for the virtual projectile, i.e., extends an adjustment space of the virtual shooting prop in the charge stage, which enriches a charging effect of the virtual shooting prop, thereby enriching an application mechanism of the virtual shooting prop, and improving an interaction effect between the user and the virtual scene when the user controls the virtual shooting prop to perform shooting.

Based on FIG. 2, FIG. 3 is a flowchart of a virtual prop control method according to an exemplary embodiment of the present disclosure. As shown in FIG. 3, the solution shown in FIG. 2 may further include the following operation 230c.

Operation 230c: Skip, in response to the shooting charge operation being in a sixth operation stage and a phase ending operation performed in parallel with the shooting charge operation being received, the sixth operation stage of the shooting charge operation and start a seventh operation stage of the shooting charge operation, the sixth operation stage being any one of the N charge stages, and the seventh operation stage being a phase that is in the N charge stages and the second operation stage and that is after the sixth operation stage.

The phase ending operation indicates that a current operation stage is ended. After the phase ending operation is completed, the shooting charge operation enters a next phase of the current operation stage.

That the phase ending operation is performed in parallel with the shooting charge operation may mean that during execution of the shooting charge operation, the phase ending operation is additionally performed without interrupting the shooting charge operation.

In one embodiment, the phase ending operation may be another operation independent of the shooting charge operation.

For example, when the user touches and holds, with one hand, the use control corresponding to the virtual shooting prop in the scene interface to perform the shooting charge operation, the user may use the other hand to tap a target control or a blank area in the scene interface, to trigger the phase ending operation, or the user may hold a physical button of the device to complete the phase ending operation.

In another embodiment, the phase ending operation may be incorporated into the shooting charge operation, or the phase ending operation may be a part of the shooting charge operation.

For example, the user touches and holds, with one hand, the use control corresponding to the virtual shooting prop in the scene interface to perform the shooting charge operation. During the touching and holding by the user, the user may lift a finger to quickly perform double-tap on the screen and then further perform the touching and holding. In this case, the operation of lifting a finger to quickly perform double-tap on the screen may be used as the phase ending operation. In addition, the operation of lifting a finger to quickly perform double-tap on the screen and then further performing the touching and holding does not interrupt the current shooting charge operation.

In one embodiment, after the phase ending operation is performed and the seventh operation stage of the shooting charge operation is started, a buff of the sixth operation stage is not applied to the virtual projectile.

In one embodiment, after the phase ending operation is performed and the seventh operation stage of the shooting charge operation is started, the buff of the sixth operation stage may be applied to the virtual projectile.

In an exemplary embodiment, the user may skip the current charge stage through the phase ending operation other than the shooting charge operation, to directly start a next charge stage, so as to quickly select a desired charge stage, and obtain a buff corresponding to the charge stage, which effectively improves efficiency of buff selection by the user, increases operation manners for the user to select different buffs for the virtual projectile, and improves the interaction effect between the user and the virtual scene when the user controls the virtual shooting prop to perform shooting.

In some embodiments, in response to a duration of the shooting charge operation in the sixth operation stage reaching a duration threshold and the phase ending operation being received, the sixth operation stage of the shooting charge operation is skipped, and the seventh operation stage of the shooting charge operation is started.

The duration threshold is less than a maximum duration of the sixth operation stage.

When the user performs the phase ending operation, a mis-operation may occur. For example, the user continuously performs the phase ending operation twice in a short time, but the phase ending operation performed for the second time is a mis-operation. In view of the problem, In an exemplary embodiment, after the shooting charge operation enters the sixth operation stage, the sixth operation stage may not be allowed to be skipped within an initial duration threshold. Only when the shooting charge operation is in the sixth operation stage and a duration of the sixth operation stage exceeds the foregoing duration threshold, the user is allowed to actively skip the sixth operation stage.

For example, it is assumed that a maximum duration of the sixth operation stage is two seconds, and the duration threshold is one second. When the user performs the shooting charge operation, a duration of the shooting charge operation in the sixth operation stage reaches 1.5 seconds, and the user triggers the phase ending operation. In this case, the shooting charge operation enters the seventh operation stage, and a buff corresponding to the seventh operation stage is applied to the virtual projectile. In some embodiments, when the user performs the shooting charge operation, the duration of the shooting charge operation in the sixth operation stage does not reach one second (for example, 0.5 seconds). In this case, the application corresponding to the virtual scene may pause receiving of the phase ending operation. Alternatively, even if the phase ending operation is received, the application corresponding to the virtual scene does not respond to the phase ending operation (i.e., does not skip the sixth operation stage).

In an exemplary embodiment, the current charge stage may be skipped only when a duration of the shooting charge operation in the current charge stage reaches the duration threshold. Through the setting of the duration threshold, a case that the current charge stage is erroneously skipped as result of a mis-operation performed by the user is avoided, and accuracy of user operations is ensured, thereby improving the interaction efficiency between the user and the virtual scene, and ensuring user experience. In addition, through the combination of the duration condition and the phase ending operation, operation manners for the user to select different buffs for the virtual projectile are increased, and the interaction effect between the user and the virtual scene when the user controls the virtual shooting prop to perform shooting is improved.

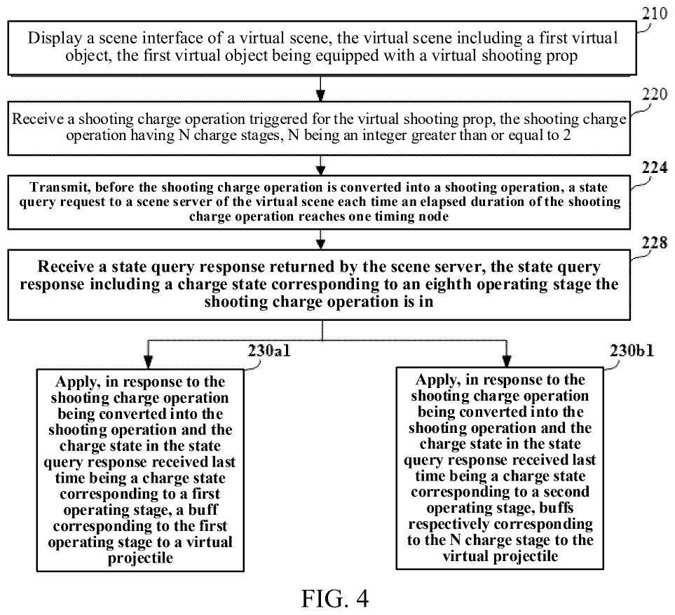

Based on the embodiment shown in FIG. 2 or FIG. 3, FIG. 4 is a flowchart of a virtual prop control method according to an exemplary embodiment of the present disclosure. As shown in FIG. 4, operation 230a may be implemented as operation 230a1, and operation 230b may be implemented as operation 230b1. Before operation 230a1 and operation 230b1, the method further includes operation 224 and operation 228.

Operation 224: Transmit, before the shooting charge operation is converted into the shooting operation, a state query request to a scene server of the virtual scene each time an elapsed duration of the shooting charge operation reaches one timing node, the state query request including the elapsed duration.

In an exemplary embodiment, the N charge stages and the second operation stage each include a plurality of timing nodes.

Time lengths indicated by the timing nodes may be the same or different. Each timing node may correspond to a start moment, a middle moment, or an end moment of a charge stage/the second operation stage. The timing node may be represented by a duration of a single charge stage/the second operation stage, or the timing node may be represented by the duration of the shooting charge operation. When the elapsed duration of the shooting charge operation reaches a timing node, the computer device may transmit a state query request to the scene server of the virtual scene.

In some embodiments, the state query request includes an elapsed operation duration of the shooting charge operation.

Operation 228: Receive a state query response returned by the scene server, the state query response including a charging state corresponding to an eighth operation stage the shooting charge operation is in, the eighth operation stage being one of the N charge stages and the second operation stage.

The charging state is determined by the scene server of the virtual scene based on the elapsed duration included in the state query request, and is notified to the computer device.

For example, the scene server receives the state query request, extracts the elapsed duration in the state query request, and determines, based on maximum durations respectively corresponding to the N charge stages and the foregoing elapsed duration, an operation stage, of the N charge stages and the second operation stage, the shooting charge operation is currently in.

For example, it is assumed that two charge stages, i.e., a charge stage 1 and a charge stage 2 exist. A maximum duration of the charge stage 1 is 2 s, and a maximum duration of the charge stage 2 is 3 s. If the elapsed duration included in the state query request is 1 s, the scene server may determine that the shooting charge operation is currently in the charge stage 1, and in this case, the returned state query response includes a charging state corresponding to the charge stage 1. If the elapsed duration included in the state query request is 3 s, the scene server may determine that the shooting charge operation is currently in the charge stage 2, and in this case, the returned state query response includes a charging state corresponding to the charge stage 2. If the elapsed duration included in the state query request is 6 s, the scene server may determine that the shooting charge operation is currently after the charge stage 2 (i.e., the second operation stage), and in this case, the returned state query response includes a charging state corresponding to the second operation stage.

The charging state may be configured for indicating an operation stage in which the shooting charge operation is currently located. The operation stage is one of the N charge stages and the second operation stage.

To be specific, the charging state is state information indicating one of the N charge stages the shooting charge operation is currently in, or the charging state is state information indicating that the shooting charge operation is currently after the N charge stages (i.e., the second operation stage).

In one embodiment, if the user is allowed to skip a current charge stage through a phase ending operation, before the shooting charge operation is converted into the shooting operation, a phase skipping notification is transmitted to the scene server of the virtual scene in response to the phase ending operation being received. The phase skipping notification includes the elapsed duration of the shooting charge operation. When the phase skipping notification is received, the scene server may determine, based on the elapsed duration included in the phase skipping notification, a sixth operation stage to be skipped by the user, and update a maximum duration of the sixth operation stage to a duration of the shooting charge operation in the sixth operation stage. In this way, when the user skips one or more charge stages through the phase ending operation, when a state query request is subsequently received, the scene server can accurately determine, based on the elapsed duration included in the state query request, an operation stage the shooting charge operation is in.

For example, it is assumed that three charge stages, i.e., a charge stage 1, a charge stage 2, and a charge stage 3 exist, and maximum durations of the three charge stages are all two seconds by default if the three charge stages are not skipped.

Case one: When the elapsed duration of the shooting charge operation reaches two seconds, one timing phase is reached. In this case, the computer device transmits a state query request to the scene server, which includes the elapsed duration of two seconds. The scene server determines, based on the elapsed duration, that the shooting charge operation undergoes the charge stage 1 and enters the charge stage 2. In this case, a returned state query response includes a charging state corresponding to the charge stage 2. When the elapsed duration of the shooting charge operation reaches three seconds, the user performs a phase ending operation. In this case, the computer device skips the charge stage 2, enters the charge stage 3, and transmits a phase skipping notification to the scene server, which includes the elapsed duration of three seconds. When the phase skipping notification is received, the scene server determines, based on the elapsed duration (3 s), that the shooting charge operation skips the charge stage 2 when lasting for one second in the charge stage 2, and therefore adjusts a maximum duration of the charge stage 2 to one second. Subsequently, when the elapsed duration of the shooting charge operation reaches five seconds, another timing phase is reached. In this case, the computer device transmits a state query request to the scene server, which includes the elapsed duration of five seconds. The scene server determines, based on the elapsed duration and the previously adjusted maximum duration (one second) of the charge stage 2, that the shooting charge operation undergoes the charge stage 3, and enters a second operation stage after the charge stage 3. In this case, a returned state query response includes a charging state corresponding to the second operation stage.

Case two: When the elapsed duration of the shooting charge operation reaches two seconds, one timing phase is reached. In this case, the computer device transmits a state query request to the scene server, which includes the elapsed duration of two seconds. The scene server determines, based on the elapsed duration, that the shooting charge operation undergoes the charge stage 1, and enters the charge stage 2. In this case, a returned state query response includes a charging state corresponding to the charge stage 2. Later, the user does not perform a phase ending operation. Correspondingly, the computer device does not transmit a phase skipping notification, and the scene server does not modify a maximum duration of each charge stage. Subsequently, when the elapsed duration of the shooting charge operation reaches five seconds, another timing phase is reached. In this case, the computer device transmits a state query request to the scene server, which includes the elapsed duration of five seconds. The scene server determines, based on the elapsed duration and the unadjusted maximum duration of each charge stage, that the shooting charge operation is currently in the charge stage 3 and does not enter the second operation stage after the charge stage 3. In this case, a returned state query response includes a charging state corresponding to the charge stage 3.

For example, the charging state corresponding to the eighth operation stage may be further configured for indicating an operation duration of the current shooting charge operation or a specific time point in the eighth operation stage, or indicating whether charging of the current shooting charge operation starts in the eighth operation stage.

Operation 230a1: Apply, in response to the shooting charge operation being converted into the shooting operation and the charging state in the state query response received last time being a charging state corresponding to the first operation stage, the buff corresponding to the first operation stage to the virtual projectile.

The state query response received last time is a state query response that is received at a time closest to a time at which the shooting charge operation is converted before the shooting charge operation is converted into the shooting operation.

In an exemplary embodiment, when the computer device detects that the shooting charge operation is converted into the shooting operation, the computer device may not directly use a charge stage of a locally detected shooting charge operation to apply a buff to the virtual projectile, but may apply a corresponding buff to the virtual projectile by using a charge stage corresponding to the charging state in the state query response fed back by the scene server last time. In this way, a buff of a charge stage applied to the virtual projectile can be synchronously applied to the virtual projectile on both the computer device side and the scene server side.

Operation 230b1: Apply, in response to the shooting charge operation being converted into the shooting operation and the charging state in the state query response received last time being a charging state corresponding to the second operation stage, the buffs respectively corresponding to the N charge stages to the virtual projectile.

In an exemplary embodiment, when the computer device detects that the shooting charge operation is converted into the shooting operation, the computer device may not directly use the second operation stage the locally detected shooting charge operation is in to apply a buff to the virtual projectile, but determines an operation stage corresponding to a charging state in a state query response fed back by the scene server last time, and applies the buffs respectively corresponding to all of the N charge stages to the virtual projectile if the operation stage corresponding to the charging state in the state query response fed back by the scene server last time is the second operation stage. In this way, buffs of all charge stages can be synchronously applied to the virtual projectile on both the computer device side and the scene server side.

In an exemplary embodiment, when the shooting charge operation is converted into the shooting operation, the computer device determines, based on the buff corresponding to the charging state in the state query response received last time, the buff to be applied to the virtual projectile when the shooting charge operation is converted into the shooting operation, to ensure the buffs synchronously applied to the virtual projectile on both the computer device side and the scene server side, avoid a problem that the buffs applied to the virtual projectile on both the computer device side and the scene server side are inconsistent, and improve accuracy of the buff applied to the virtual projectile, thereby improving an interaction effect between the user and the virtual scene when the user controls the virtual shooting prop to perform shooting.

In some embodiments, the buff corresponding to each of the N charge stages includes at least one of the following:
an attribute change value generated by the virtual projectile increases;
a spread range of the virtual projectile decreases;
a collision range of the virtual projectile increases;
a flight speed of the virtual projectile increases; or
a ballistic trajectory of the virtual projectile changes.

The attribute may be any one or more of attributes such as a health point, a mana point, an attack power, a speed, or a strength. A type of the attribute is not limited In an exemplary embodiment.

The spread range is a maximum range by which the virtual projectile launched by the virtual shooting prop deviates from a crosshair of the virtual shooting prop at a specified distance. For example, the spread range may be a range covered by a circle formed by using a center of the crosshair of the virtual projectile as a center and a specific length as a radius, or another shape.

The collision range is a damage range generated by the virtual projectile in the virtual scene. For example, the collision range may be a space obtained through outward extension by a particular distance based on a shape of the virtual projectile and by using the center of mass of the virtual projectile as a center.

The flight speed may be an initial speed after the virtual projectile is released, or the flight speed may include an initial speed after the projectile is released and an acceleration after the virtual projectile is launched.

That the ballistic trajectory changes may be that the virtual projectile may change a direction and move according to a trajectory of a preset curve or a trajectory of a curve calculated in real time.

Each of the N charge stages corresponds to one or more types of the foregoing buff types. In some embodiments, different charge stages may not completely correspond to the same charge stage, or may completely correspond to different types of buffs.

In an exemplary embodiment, the buff corresponding to each charge stage may be one or more of a plurality of different types of buffs, which extends a type of the buff applied to the virtual projectile. In addition, the user may control the duration of the shooting charge operation, to obtain a buff that satisfies a particular demand, so as to satisfy a target demand in the virtual scene more effectively, thereby effectively improving the interaction effect between the user and the virtual scene when the user controls the virtual shooting prop to perform shooting.

In some embodiments, in response to the buff including that an attribute change value generated by the virtual projectile increases, the attribute change value is positively correlated with a duration of the shooting charge operation in the charge stage corresponding to the buff.

In a charge stage, a longer duration of the shooting charge operation indicates a larger attribute change value corresponding to the virtual projectile.

For example, it is assumed that the buff of the 1^{st} charge stage is generating additional damage, and the attribute change value is a damage value. In this case, a longer duration of the shooting charge operation in the 1^{st} charge stage indicates a larger damage value, which indicates higher additional damage generated by the buff. For example, the shooting charge operation is converted into a shooting operation when the duration of the shooting charge operation in the 1^{st} charge stage reaches 0.5 seconds, and the buff applied to the virtual projectile is generating additional damage of 20%. The shooting charge operation is converted into the shooting operation when the duration of the shooting charge operation in the 1^{st} charge stage reaches one second, and the buff applied to the virtual projectile is generating additional damage of 40%.

In an exemplary embodiment, the user may control the attribute change value of the virtual projectile by controlling the duration of the shooting charge operation, so as to satisfy a control precision demand of the user in a virtual shooting scenario, which extends a method for the user to control a magnitude of the attribute value of the virtual projectile through the duration, and extends an operation for the user to select different buffs for the virtual projectile, thereby effectively improving the interaction effect between the user and the virtual scene.

In some embodiments, in response to the buff including that a spread range of the virtual projectile decreases, the spread range is negatively correlated with the duration of the shooting charge operation in the charge stage corresponding to the buff.

A longer duration of the shooting charge operation in the charge stage corresponding to the buff indicates a smaller spread range of the virtual projectile, which indicates higher shooting precision of the virtual shooting prop.

In an exemplary embodiment, the user may control the spread range of the virtual projectile by controlling the duration of the shooting charge operation, so as to effectively control a shooting precision of the virtual shooting prop, which extends a method for the user to control the shooting precision of the virtual shooting prop through the duration, and extends an operation manner for the user to select different buffs for the virtual projectile, to satisfy a target demand of the user in a virtual shooting scenario, thereby effectively improving the interaction effect between the user and the virtual scene.

In some embodiments, in response to the buff including that a collision range of the virtual projectile increases, the collision range is positively correlated with the duration of the shooting charge operation in the charge stage corresponding to the buff.

The collision range is configured for detecting, after the virtual projectile is launched, whether an aimed target object collides with the virtual projectile.

The collision range may have different shapes, and may be any one of a spherical collision range, a box collision range, or a grid collision range.

A longer duration of the shooting charge operation in the charge stage corresponding to the buff indicates a larger collision range of the virtual projectile, which indicates less difficulty in colliding with the aimed target object to generate damage to the target object.

In an exemplary embodiment, a larger collision range of the virtual projectile indicates less difficulty in hitting the target object by the virtual shooting prop, which provides a virtual shooting assistance manner for the user, so that the user controls the duration of the shooting charge operation to control a hit rate of the virtual shooting, which extends an operation manner for the user to select different buffs for the virtual projectile, thereby effectively improving the interaction effect between the user and the virtual scene.

In some embodiments, in response to the buff including that a flight speed of the virtual projectile increases, the flight speed is positively correlated with the duration of the shooting charge operation in the charge stage corresponding to the buff.

A longer duration of the shooting charge operation in the charge stage corresponding to the buff indicates a higher flight speed of the virtual projectile, which indicates stronger damage that can be generated.

In an exemplary embodiment, a higher flight speed of the virtual projectile indicates a higher shooting speed of the virtual shooting prop, which extends a method for the user to determine a shooting speed of the virtual shooting prop by controlling the duration of the shooting charge operation, and extends an operation manner for the user to select different buffs for the virtual projectile, to satisfy a target demand of the user in a virtual shooting scenario, so that the interaction effect between the user and the virtual scene can be effectively improved.

In conclusion, in the foregoing plurality of embodiments of the present disclosure, effect strengths corresponding to different buffs are determined in combination with the duration of the shooting charge operation, which extends a method for determining a buff, thereby effectively improving the interaction effect between the user and the virtual scene when the user controls the virtual shooting prop to performing shooting.

In one embodiment, in response to the shooting charge operation proceeding to a third operation stage, a first special effect corresponding to the third operation stage is applied to the virtual projectile, the third operation stage being any one of the N charge stages and the second operation stage.

Special effects of the virtual shooting prop respectively corresponding to the N charge stages and the second operation stage may be different special effects.

As used herein, the term “special effects” may refer to visual, auditory, or physical-based effects that enhance the realism, atmosphere, or interactivity of the virtual environment. For example, visual effects may include particle effects, such as explosions, fire, smoke, rain, snow, fog; lighting and shadow effects; magic or skill effects in character actions; and/or environment effects such as water ripples or reflections, etc. Audio effects may include echo, reverb, and/or spatial sound effects that make the environment more immersive. Physics-based effects may include realistic interactions like debris scattering, cloth movement, object vibration, object destruction, etc. Special effects may be implemented through real-time rendering techniques, combining graphics algorithms, physics simulations, and shader programming, etc. In some cases, visual effects may be further enhanced by applying motion blur, bloom, color grading, depth of field, lens flare, etc., after the main rendering process. In some embodiments, “special effects” may be artificially created effects used to simulate phenomena that are difficult or impossible to achieve in real life or in real-time rendering.

The first special effect may be a visual special effect or a vibrating special effect presented by the virtual shooting prop in the virtual scene. In some embodiments, when the third operation stage is the second operation stage, the visual special effect or the vibrating special effect corresponding to the virtual shooting prop may be a superimposed special effect of visual special effects or vibrating special effects of the N charge stages, or may be a strengthened version of a visual special effect or a vibrating special effect of a last charge stage. The visual special effect or the vibrating special effect of the virtual shooting prop not only can prompt the user of a current operation stage the shooting charge operation is in, but also can prompt the user of a duration of the shooting charge operation in the current operation stage through the visual special effect or the vibrating special effect. For example, the first special effect includes a visual special effect, and the visual special effect is an animation. A playback process of the animation can prompt the user that the shooting charge operation is currently in a specific charge stage or the second operation stage, and a playback progress of the animation can prompt the user of a duration of the shooting charge operation in the current phase.

Exemplarily, when the virtual shooting prop is a virtual arch, the first special effect may be that the virtual arch emits a special light effect animations or a vibration effect. In different operation stages, the virtual arch may emit different light effect animations or vibration effects.

In an exemplary embodiment, the computer device determines the special effect corresponding to the virtual shooting prop based on the operation stage the shooting charge operation is in, to prompt the user of the operation stage the shooting charge operation is in through the special effect corresponding to the virtual shooting prop, which helps the user identify the current operation stage, thereby improving the interaction effect between the user and the virtual scene when the user controls the virtual shooting prop to perform shooting.

In one embodiment, in response to the shooting charge operation proceeding to a fourth operation stage, a second special effect corresponding to the fourth operation stage is applied to the virtual projectile, the fourth operation stage being any one of the N charge stages and the second operation stage.

The second special effect may be a UI-display special effect of the virtual projectile, for example, a visual special effect or a vibrating special effect of the virtual projectile presented in the virtual scene. The computer device may present different UI-display special effects of the virtual projectile based on a current operation stage the shooting charge operation is in. The UI-display special effect may be any one or more of a color, an appearance, a brightness, a light effect, an animation, or a vibration effect of the virtual projectile.

For example, the shooting charge operation is in the second operation stage, the second operation stage includes a charge stage A2 and a charge stage B2, a UI-display special effect corresponding to the charge stage A2 is that the virtual projectile displays a red light, and a UI-display special effect corresponding to the charge stage B2 is that the virtual projectile displays a high luminance. When the user controls the shooting charge operation to last from a start moment of the second operation stage to an end moment of the second operation stage, the user may first see the virtual projectile displaying a red light in the charge stage A2. When the charge stage B2 is started, the display luminance of the virtual projectile increases. After the charge stage B2, the virtual projectile displays a red light, and the display luminance increases.

The visual special effect or the vibrating special effect of the virtual projectile not only can prompt the user of a current operation stage the shooting charge operation is in, but also can prompt the user of a duration of the shooting charge operation in the current operation stage through the visual special effect or the vibrating special effect. For example, the second special effect includes a visual special effect, and the visual special effect is an animation. A playback process of the animation can prompt the user that the shooting charge operation is currently in a specific charge stage or the second operation stage, and a playback progress of the animation can prompt the user of a duration of the shooting charge operation in the current phase.

In an exemplary embodiment, the computer device determines the UI-display special effect corresponding to the virtual projectile based on the operation stage the shooting charge operation is in, to prompt the user of the operation stage the shooting charge operation is in through the special effect corresponding to the virtual projectile, which helps the user identify the current operation stage, thereby improving the interaction effect between the user and the virtual scene when the user controls the virtual shooting prop to perform shooting.

In one embodiment, in response to the shooting charge operation proceeding to a fifth operation stage, a crosshair of the virtual shooting prop is displayed in the scene interface based on a crosshair effect corresponding to the fifth operation stage, the fifth operation stage being any one of the N charge stages and the second operation stage.

The computer device may display, in the scene interface based on the crosshair corresponding to the fifth operation stage, the crosshair effect of the virtual shooting prop currently used by the virtual object.

The crosshair may be displayed in any one of forms such as a cross, a circle, or a round point. In different operation stages of the N charge stages and the second operation stage, the crosshair may have different shapes.

The crosshair effect not only can prompt the user of the current operation stage the shooting charge operation is in, but also can prompt the user of the duration of the shooting charge operation in the current operation stage through the crosshair effect. For example, the crosshair effect is a gradually zoomed-out box. The crosshair in the box form can prompt the user of the current operation stage the shooting charge operation is in. A zoom-out progress of the box can prompt the user of the duration of the shooting charge operation in the current operation stage.

In an exemplary embodiment, the computer device determines the crosshair effect corresponding to the virtual shooting prop based on the operation stage the shooting charge operation is in, to prompt the user of the operation stage the shooting charge operation is in through the crosshair effect of the virtual shooting prop, which helps the user identify the current operation stage, thereby improving the interaction effect between the user and the virtual scene when the user controls the virtual shooting prop to perform shooting.

Based on the solutions shown in FIG. 2 to FIG. 4, exemplarily, the virtual scene belongs to a shooting game. Application manners of the solutions shown in the foregoing embodiments of the present disclosure are described below.

### 1. In-Match Equipment: A Virtual Shooting Prop Having a Multi-Phase Charging Function is Selected and Equipped

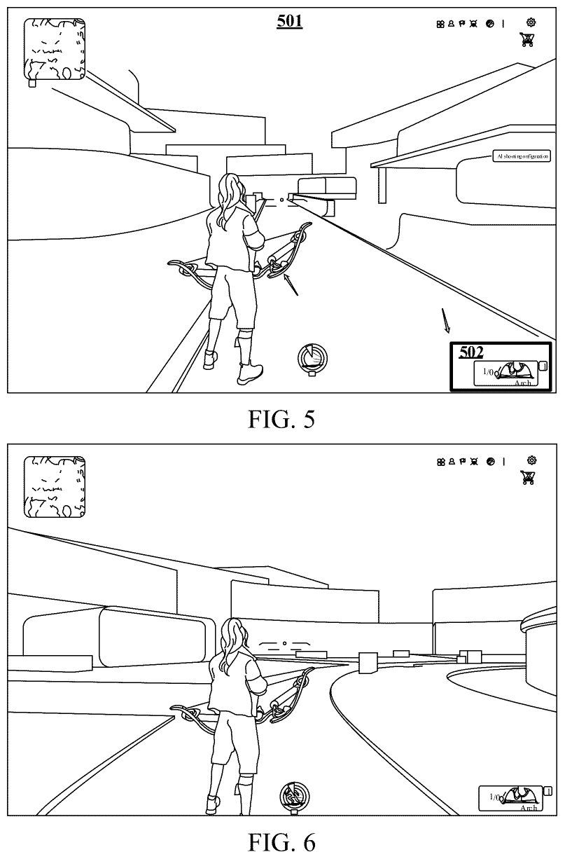

FIG. 5 is an interface diagram of shooting prop selection according to an exemplary embodiment of the present disclosure.

As shown in FIG. 5, a player may select a virtual shooting prop having a multi-phase charging function from an area 502 in a scene 501.

### 2. Charging Effect/Performance

FIG. 6 is an interface diagram of a virtual arch in an uncharged state according to an exemplary embodiment of the present disclosure.

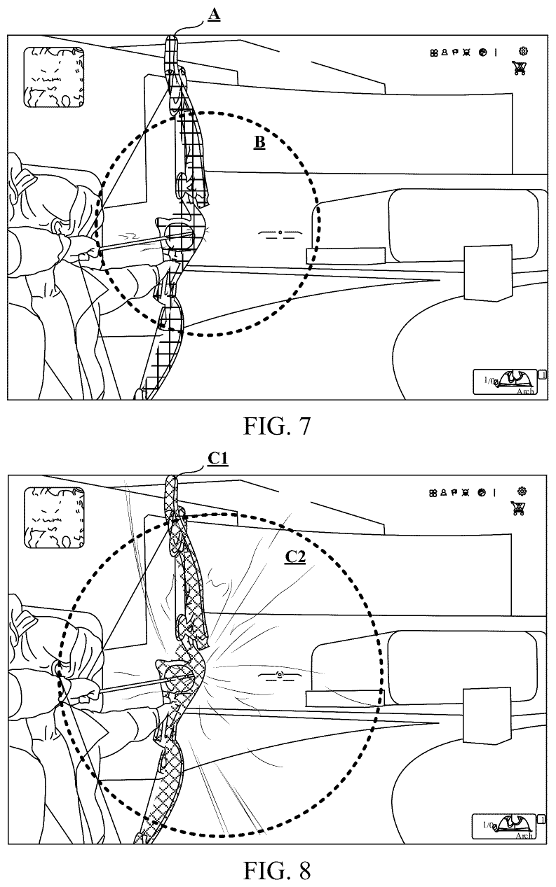

FIG. 7 is an interface diagram of the virtual arch in a first charge stage according to an exemplary embodiment of the present disclosure.

A. In the first charge stage, a firing button is touched and held for 0-0.5 s.

When the player touches and holds the firing button, the phase of 0-0.5 s is considered as the first charge stage. In this phase, the virtual arch undergoes the following changes. At this point, the player releases the fire button to obtain the following effects:

UI: A horizontal bar at a crosshair position gradually narrows, indicating to the player that precision of the shooting prop increases.

Special effects: a special effect A appears on the arch body, and a special effect B appears on an arrow body.

Prop mechanism: a spread range of the virtual arch narrows, the precision increases, and damage of the virtual arch gradually increases within 0-0.5 s as the duration of the touch and hold increases.

FIG. 8 is an interface diagram of the arch in a second charge stage according to an exemplary embodiment of the present disclosure.

B. In the second charge stage, the firing button is touched and held for 0.5-1 s.

When the player touches and holds the firing button, the period of 0.5-1 s is considered as the second charge stage. In this phase, the virtual arch undergoes the following changes. At this point, the player releases the fire button to obtain the following effects:

UI: A rotating circular animation appears at the crosshair position, indicating to the player that a hit range of the shooting prop increases.

Special effect: A special effect C1 appears on the arch body, and a converging special effect C2 appears at the arrow position.

Prop mechanism: A hit determining range of the prop increases.

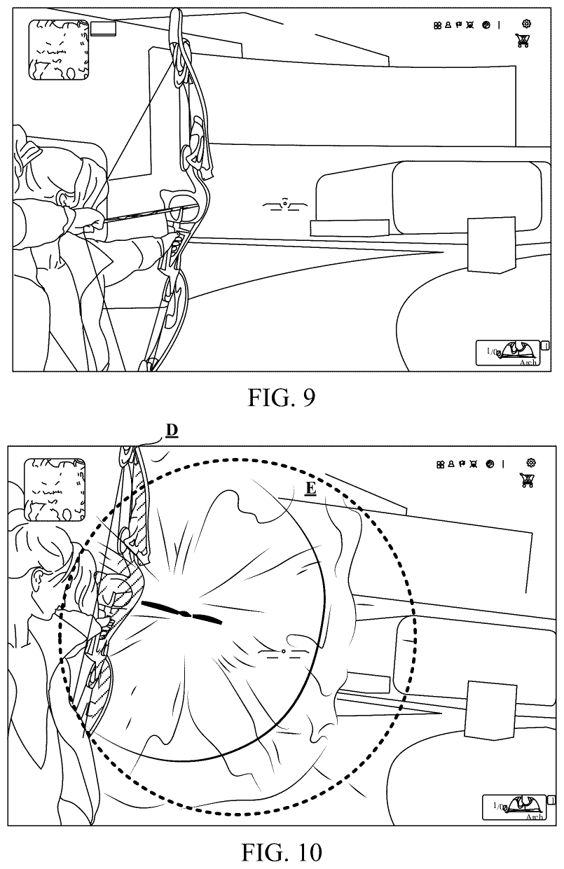

FIG. 9 is an interface diagram of the virtual arch in a third charge stage according to an exemplary embodiment of the present disclosure.

FIG. 10 is an interface diagram in which the virtual arch performs firing after undergoing the first two charge stages according to an exemplary embodiment of the present disclosure.

A phase in which the player touches and holds the firing button for is and finally releases the firing button is considered as the third charge stage (i.e., the foregoing second operation stage). At this point, the player releases the firing button to obtain the following effects:

UI: It is an effect with a crosshair stabilizing into a horizontal bar enclosed by a circular frame, indicating to the player that all charging effects are now completed.

Special effects: A special effect D appears on the arch body, and a backward light effect E appears at the arrow position.

Prop mechanism: The prop retains all buffs of all previous charge stages, including damage increase, precision increase, and hit determining range increase.

The first charge stage and the second charge stage correspond to the N charge stages in the solutions shown in FIG. 2 to FIG. 4, and the third charge stage corresponds to the second operation stage in the solutions shown in FIG. 2 to FIG. 4.

On a technical side, this solution is implemented as follows:

### 1. Two Solutions for Multi-Phase Charging

Solution A: It merely provides effects. The charging effect is divided into a plurality of charge stages to create distinct effects.

The charging effect is extended. For example, a charging effect with a complete time length of three seconds is provided, which includes three charging effects A, B, and C each having one second. When the player touches and holds a button, a client sequentially plays the effects A, B, and C. At this point, the player releases the button to determine a charging condition.

In this way, distinct effects can be achieved during the charging, and animations/special effects/UI effects are played sequentially, providing the player with an illusion of distinction.

Option B: Proactive state query/modification is performed during charging, so that a server and a client maintain synchronized states, to achieve true phase-by-phase charging.

A charge stage is defined as starting from a moment at which Button Down is monitored to a moment at which Button UP is monitored, during which records are only made at button holding and releasing moments. However, actually, it is possible to implement continuous recording through creation of more conditions during button holding by the user, such as querying and state delivering in a server tick (without interrupting the effect on the client), creating a local timer on the client (using frame synchronization instead of state synchronization for real-time changes), or querying a state of the player at a fixed time node by using some ready-made time-based blueprint tools, such as a TL timing manager, or even achieving a new effect at the fixed node.

Therefore, the charging process is converted from buttondown-buttonup to buttondown-timing node 1-time node 2-timing node N-buttonup. As long as the player does not release the button, the player can freely define a charge stage, a duration, and a quantity of phases in an entire button holding process.

In addition, because the process is relatively complete, the player performs a state change at the buttonup, and performs matching with a packet transmitted by a previous timing node, so that a state of a current charge stage can be directly obtained, which achieves a more flexible mechanism.

### 2. Implementation of Multi-Phase Charging

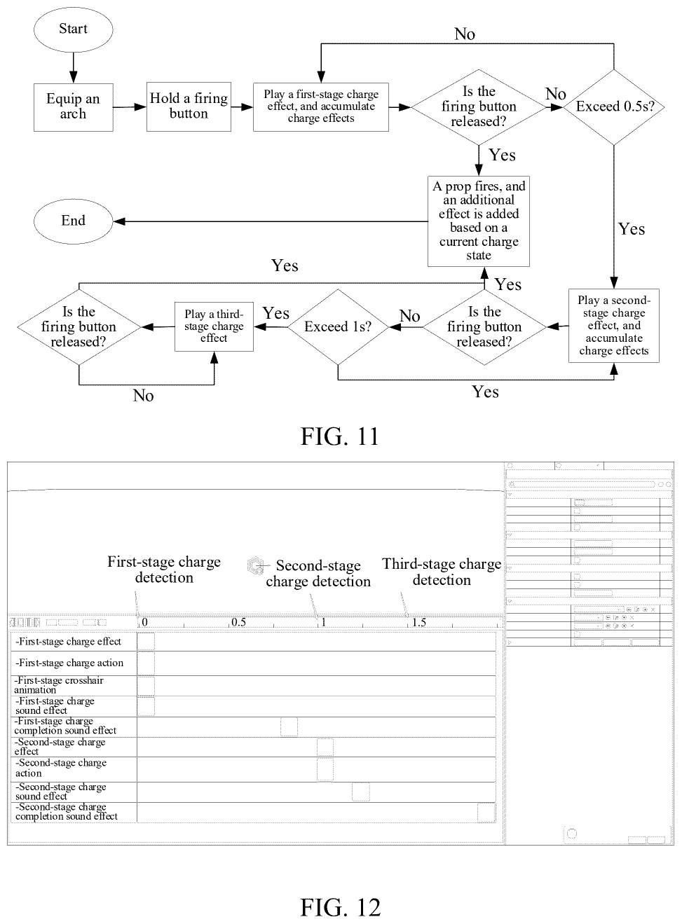

FIG. 11 is a flowchart of an implementation of multi-phase charging according to an exemplary embodiment of the present disclosure.

### Solution A: Recording During Charging

### A. Common Charging State Practice:

A time at which the player holds a firing button is recorded, and a Button Down state is assigned. As long as the virtual shooting prop retains the Button Down state, it is considered that the virtual shooting prop is in a charging state. When the player releases the firing button and records Button Up, it is determined whether the time in Button Down is sufficient and whether a charging condition is satisfied.

1) If the condition is satisfied, firing is allowed or another effect is applied.

2) If the condition is not satisfied, firing is canceled or an effect cannot be applied.

FIG. 12 is a schematic diagram of timing management introduced based on button recording according to an exemplary embodiment of the present disclosure.

Based on recording Button Down/Up merely depending whether a button is held, the solution shown In an exemplary embodiment may further implement time-based and tick-based recording on a state after the Button Down is held. Even if the player continuously maintains the Button Down state, the charging state of the player is queried/modified at a specified time node.

As shown in FIG. 12, at three specified nodes, i.e., 0 s/1 s/2 s, a charging state of a character is queried and modified, and effects of a prop mechanism/a special effect/a UI/a sound effect are modified, which implements significantly different effects of the prop when the player continuously holds a firing button without firing.

When the player releases the firing button to initiate Button Up, another determining is performed, so that an accurate charge stage and effect can be obtained.

### 3. Implementation Principle of a Prop Mechanism Change During Charging

### 1) Damage of the Prop Increases

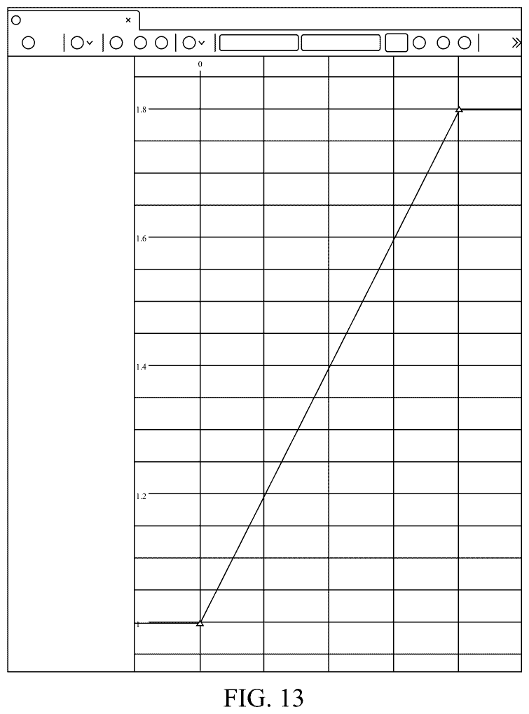

FIG. 13 is a schematic diagram of a prop damage amplification curve according to an exemplary embodiment of the present disclosure.

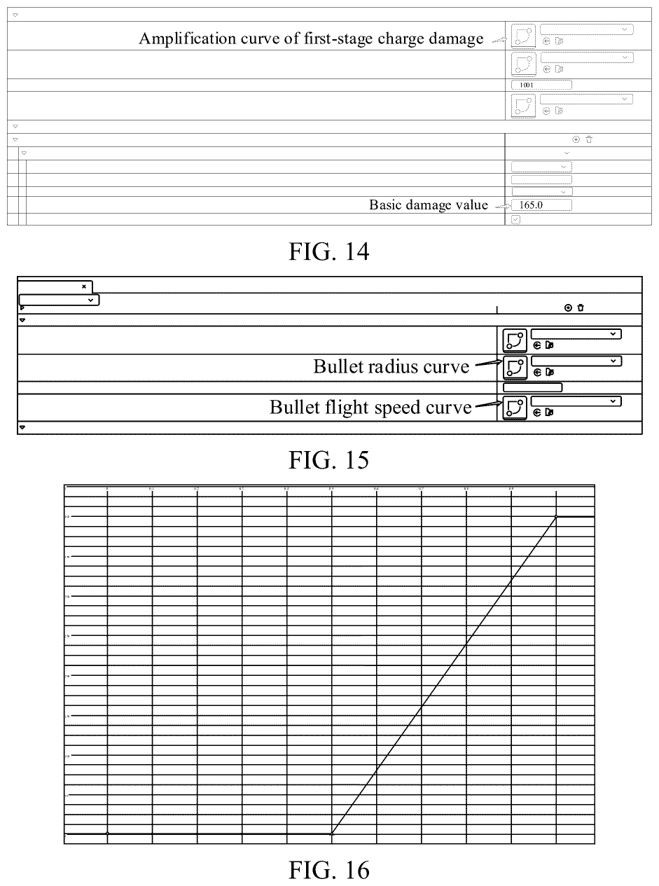

FIG. 14 is a schematic diagram of damage amplification introduced to a charging mechanism according to an exemplary embodiment of the present disclosure.

Based on the fixed damage, an additional time-variable damage curve is introduced. A horizontal axis represents a holding duration of a firing button within a single charge stage. When the player holds the firing button, damage increases as the holding duration increases. Because changes during the charging are recorded in real time, the second/third charge stage does not continuously affect the damage of the prop.

### 2) Hit Determining Range and Flight Speed of the Prop Increase

FIG. 15 is a schematic diagram of bullet radius amplification and flight speed increase in the charging mechanism according to an exemplary embodiment of the present disclosure.

FIG. 16 is a schematic diagram of a bullet radius amplification curve in the charging mechanism according to an exemplary embodiment of the present disclosure.

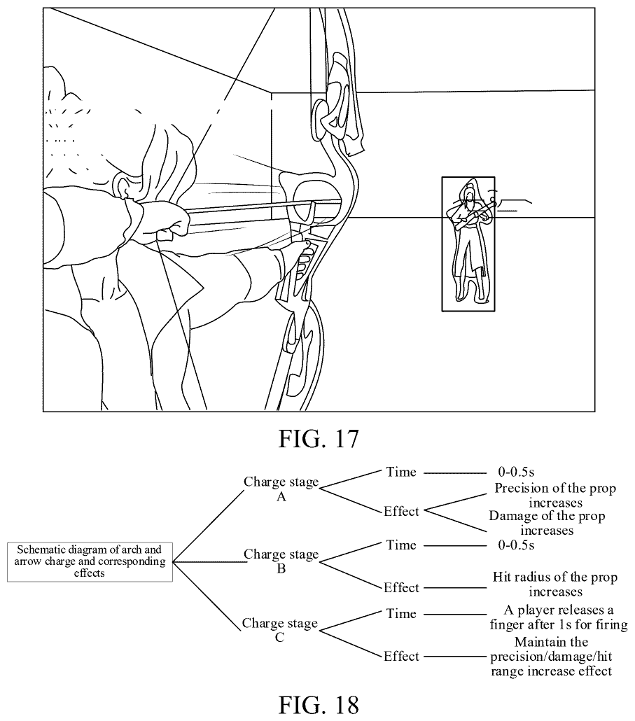

FIG. 17 is a schematic diagram of a collision box according to an exemplary embodiment of the present disclosure.

A hit range increase effect is achieved through adjustment of a bullet radius. Under normal conditions, a bullet is launched or fired in a form of a volume-less line. Nevertheless, during charging, after a second charge stage is started, a radius of the bullet line further increases. Even if a crosshair of a player is not aimed at a target, as long as the radius of the bullet overlaps the collision box of the target enemy, damage can be generated. As shown in the following figure, as long as a circle of the crosshair contacts the collision box of the target enemy, damage can be generated.

FIG. 18 is a schematic diagram of arch and arrow charging and corresponding effects according to an exemplary embodiment of the present disclosure.

In an exemplary embodiment, while the player interaction process (hold-release) is maintained, more recording occasions and tag processing are introduced to the charge stage. A plurality of charge stages may be defined based on time/states, allowing a player to obtain distinct mechanism effects when charging to different phases. This is complemented by refined interaction prompt, to provide distinct effects based on the holding duration without changing the player interaction. For the player, the operation remains consistent, i.e., holding the firing button for charging and releasing the firing button for firing. However, because the charge stage is divided to provide distinct effects based on the time and states, the player may select proper charging durations for different scenarios to obtain a most effective prop effect. The player adjusts the charge stage to implement different prop mechanisms, which enhances diversity and effects of props. Moreover, the combined solution of button recording and timing management is used, in which only critical time nodes are controlled, which omits dependence on specific charging mechanisms, and may be reused on various virtual shooting props without additional development efforts.

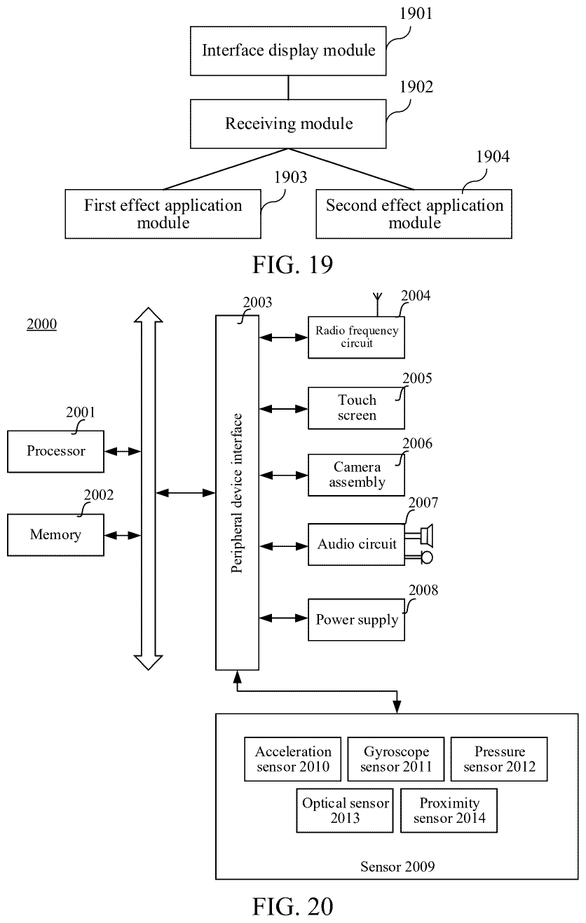

FIG. 19 is a block diagram of a virtual prop control apparatus according to an exemplary embodiment of the present disclosure. The apparatus is controlled by a computer device, and includes:
an interface display module 1901, configured to display a scene interface of a virtual scene, the virtual scene including a first virtual object, the first virtual object being equipped with a virtual shooting prop;
a receiving module 1902, configured to receive a shooting charge operation triggered for the virtual shooting prop, the shooting charge operation having up to N charge stages, N being an integer greater than or equal to 2;
a first effect application module 1903, configured to apply, in response to the shooting charge operation being converted into a shooting operation in a first operation stage, a buff corresponding to the first operation stage to a virtual projectile launched by the virtual shooting prop, the first operation stage being one of the N charge stages, and buffs respectively corresponding to the N charge stages being different; and
a second effect application module 1904, configured to apply, in response to the shooting charge operation being converted into the shooting operation in a second operation stage, the buffs respectively corresponding to the N charge stages to the virtual projectile, the second operation stage being after the N charge stages.

In some embodiments, the buff corresponding to each charging time period includes at least one of the following:
an attribute change value generated by the virtual projectile increases;
a spread range of the virtual projectile decreases;
a collision range of the virtual projectile increases;
a flight speed of the virtual projectile increases; or
a ballistic trajectory of the virtual projectile changes.

In some embodiments, in response to the buff including that an attribute change value generated by the virtual projectile increases, the attribute change value is positively correlated with a duration of the shooting charge operation in the charge stage corresponding to the buff.

In some embodiments, in response to the buff including that a spread range of the virtual projectile decreases, the spread range is negatively correlated with the duration of the shooting charge operation in the charge stage corresponding to the buff.

In some embodiments, in response to the buff including that a collision range of the virtual projectile increases, the collision range is positively correlated with the duration of the shooting charge operation in the charge stage corresponding to the buff.

In some embodiments, in response to the buff including that a flight speed of the virtual projectile increases, the flight speed is positively correlated with the duration of the shooting charge operation in the charge stage corresponding to the buff.

In some embodiments, the apparatus further includes:

a first special effect application module, configured to apply, in response to the shooting charge operation proceeding to a third operation stage, a first special effect corresponding to the third operation stage to the virtual projectile, the third operation stage being any one of the N charge stages and the second operation stage.

In some embodiments, the apparatus further includes:

a second special effect application module, configured to apply, in response to the shooting charge operation proceeding to a fourth operation stage, a second special effect corresponding to the fourth operation stage to the virtual projectile, the fourth operation stage being any one of the N charge stages and the second operation stage.

In some embodiments, the apparatus further includes:

a crosshair display module, configured to display, in response to the shooting charge operation proceeding to a fifth operation stage, a crosshair of the virtual shooting prop in the scene interface based on a crosshair effect corresponding to the fifth operation stage, the fifth operation stage being any one of the N charge stages and the second operation stage.

In some embodiments, the apparatus further includes:

a skipping module, configured to skip, in response to the shooting charge operation being in a sixth operation stage and a phase ending operation performed in parallel with the shooting charge operation being received, the sixth operation stage of the shooting charge operation and start a seventh operation stage of the shooting charge operation, the sixth operation stage being any one of the N charge stages, and the seventh operation stage being a phase that is in the N charge stages and the second operation stage and that is after the sixth operation stage.

In some embodiments, the skipping module is configured to skip, in response to a duration of the shooting charge operation in the sixth operation stage reaching a duration threshold and the phase ending operation being received, the sixth operation stage of the shooting charge operation, and start the seventh operation stage of the shooting charge operation.

In some embodiments, the N charge stages and the second operation stage each include a plurality of timing nodes, and the apparatus further includes:
a request transmission module, configured to transmit, before the shooting charge operation is converted into the shooting operation, a state query request to a scene server of the virtual scene each time an elapsed duration of the shooting charge operation reaches one timing node, the state query request including the elapsed duration; and
a response receiving module, configured to receive a state query response returned by the scene server, the state query response including a charging state corresponding to an eighth operation stage the shooting charge operation is in, the eighth operation stage being one of the N charge stages and the second operation stage.

The first effect application module 1903 is configured to apply, in response to the shooting charge operation being converted into the shooting operation and the charging state in the state query response received last time being a charging state corresponding to the first operation stage, a buff corresponding to a first time period to the virtual projectile.

The second effect application module 1904 is configured to apply, in response to the shooting charge operation being converted into the shooting operation and the charging state in the state query response received last time being a charging state corresponding to the second operation stage, buffs respectively corresponding to at least two charging time periods to the virtual projectile.

In an exemplary embodiment, different buffs are set for the virtual projectile in different charge stages, and all buffs of all preceding charge stages are set for the virtual projectile after the last charge stage ends, so as to allow the user to select different types of buffs by controlling the duration of the shooting charge operation. This increases operation manners for the user to select different buffs for the virtual projectile, i.e., extends an adjustment space of the virtual shooting prop in the charge stage, which enriches a charging effect of the virtual shooting prop, thereby enriching an application mechanism of the virtual shooting prop, and improving an interaction effect between the user and the virtual scene when the user controls the virtual shooting prop to perform shooting.

When the apparatus provided in the foregoing embodiments implements functions of the apparatus, division of the foregoing various functional modules is merely used as an example for description. In an actual application, the functions may be assigned to different functional modules for completion according to actual requirements. In other words, an internal structure of a device is divided into different functional modules, to complete all or some of the functions described above.

Specific manners of performing operations by the modules of the apparatus in the foregoing embodiment have been described in detail in the embodiments related to the method. Technical effects obtained by performing the operations by the modules are the same as the technical effects in the embodiments related to the method, and details are not described herein again.

FIG. 20 is a structural block diagram of a computer device 2000 according to an exemplary embodiment of the present disclosure. The computer device 2000 may be a portable mobile terminal, such as a mobile phone or a tablet computer. The computer device 2000 may also be referred to as a user device, a portable terminal, or the like.

Generally, the computer device 2000 includes a processor 2001 and a memory 2002.

The processor 2001 may include one or more processing cores, for example, a 4-core processor or an 8-core processor. The processor 2001 may be implemented in at least one hardware form of a digital signal processor (DSP), a field programmable gate array (FPGA), or a programmable logic array (PLA). The processor 2001 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 2001 may be integrated with a graphics processing unit (GPU). The GPU is configured to render and draw content that needs to be displayed on a display screen. In some embodiments, the processor 2001 may further include an artificial intelligence (AI) processor. The AI processor is configured to process computing operations related to machine learning.

The memory 2002 may include one or more computer-readable storage media. The computer-readable storage media may be tangible and non-transient. The memory 2002 may further include a high-speed random access memory and a non-volatile memory, for example, one or more disk storage devices or flash storage devices. In some embodiments, the non-transient computer-readable storage medium in the memory 2002 is configured to store at least one instruction, and the at least one instruction is executed by the processor 2001 to implement the virtual prop control method provided in the embodiments of the present disclosure.

In some embodiments, the computer device 2000 may include a peripheral device interface 2003 and at least one peripheral device. Specifically, the peripheral device includes at least one of a radio frequency circuit 2004, a touch display screen 2005, a camera 2006, an audio circuit 2007, or a power supply 2008.

In some embodiments, the computer device 2000 further includes one or more sensors 2009. The one or more sensors 2009 include but are not limited to an acceleration sensor 2010, a gyroscope sensor 2011, a pressure sensor 2012, an optical sensor 2013, and a proximity sensor 2014.

A person skilled in the art may understand that the foregoing structures do not constitute a limitation on the computer device 2000, and the computer device may include more or fewer components than those shown in the figure, some merged components, or different component arrangements.

In an exemplary embodiment, a chip is further provided, the chip including a programmable logic circuit and/or program instructions. The chip, when run on a computer device, is configured to implement the foregoing virtual prop control method.

In an exemplary embodiment, a computer program product is further provided, the computer program product including computer instructions, the computer instructions being stored in a computer-readable storage medium. A processor of a computer device reads the computer instructions from the computer-readable storage medium and executes the computer instructions, to implement the virtual prop control method provided in the foregoing method embodiments.

In an exemplary embodiment, a computer-readable storage medium is further provided, the computer-readable storage medium having a computer program stored herein, the computer program being loaded and executed by a processor to implement the virtual prop control method provided in the foregoing method embodiments.

As such, the technical solutions provided in the present disclosure have at least the following beneficial effects. Different buffs are set for the virtual projectile in different charge stages, and all buffs of all preceding charge stages are set for the virtual projectile after the last charge stage ends, so as to allow a user to select different types of buffs by controlling a duration of the shooting charge operation. This increases operation manners for the user to select different buffs for the virtual projectile, i.e., extends an adjustment space of the virtual shooting prop in the charge stage, which enriches a charging effect of the virtual shooting prop, thereby enriching an application mechanism of the virtual shooting prop, and improving an interaction effect between the user and the virtual scene when the user controls the virtual shooting prop to perform shooting.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

A person skilled in the art may be aware that in the foregoing one or more examples, functions described in the embodiments of the present disclosure may be implemented by using hardware, software, firmware, or any combination thereof. When implemented by using software, the functions may be stored in a computer-readable medium, or may be used as one or more instructions or code in a computer-readable medium for transferring. The computer-readable medium includes a computer storage medium and a communication medium, the communication medium including any medium that enables a computer program to be transmitted from one place to another. The storage medium may be any available medium accessible to a general-purpose or dedicated computer.

The foregoing descriptions are merely exemplary embodiments of the present disclosure, and are not intended to limit the present disclosure. Any modification, equivalent replacement, or improvement made within the spirit and principle of the present disclosure shall fall within the protection scope of the present disclosure.

What is claimed is:

1. A virtual prop control method, performed by a computer device, the method comprising:
displaying a scene interface of a virtual scene, the virtual scene comprising a first virtual object, the first virtual object being equipped with a virtual shooting prop;
receiving a shooting charge operation triggered for the virtual shooting prop, the shooting charge operation having N charge stages, and N being an integer greater than or equal to 2;
applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and
applying, in response to the shooting charge operation being converted into the shooting operation in a second operation stage, the buffs corresponding to the N charge stages to the virtual projectile, the second operation stage being after the N charge stages.

2. The method according to claim 1, wherein the buff corresponding to a charge stage of the N charge stages comprises at least one of following:
an attribute change value generated by the virtual projectile increases;
a spread range of the virtual projectile decreases;
a collision range of the virtual projectile increases;
a flight speed of the virtual projectile increases; or
a ballistic trajectory of the virtual projectile changes.

3. The method according to claim 2, wherein in response to the buff comprising that the attribute change value generated by the virtual projectile increases, the attribute change value is positively correlated with a duration of the shooting charge operation in the charge stage corresponding to the buff.

4. The method according to claim 2, wherein in response to the buff comprising that the spread range of the virtual projectile decreases, the spread range is negatively correlated with a duration of the shooting charge operation in the charge stage corresponding to the buff.

5. The method according to claim 2, wherein in response to the buff comprising that the collision range of the virtual projectile increases, the collision range is positively correlated with a duration of the shooting charge operation in the charge stage corresponding to the buff.

6. The method according to claim 2, wherein in response to the buff comprising that the flight speed of the virtual projectile increases, the flight speed is positively correlated with a duration of the shooting charge operation in the charge stage corresponding to the buff.

7. The method according to claim 1, further comprising:
applying, in response to the shooting charge operation proceeding to a third operation stage, a first special effect corresponding to the third operation stage to the virtual projectile, the third operation stage being any one of the N charge stages and the second operation stage.

8. The method according to claim 7, further comprising:
applying, in response to the shooting charge operation proceeding to a fourth operation stage, a second special effect corresponding to the fourth operation stage to the virtual projectile, the fourth operation stage being any one of the N charge stages and the second operation stage.

9. The method according to claim 8, further comprising:
displaying, in response to the shooting charge operation proceeding to a fifth operation stage, a crosshair of the virtual shooting prop in the scene interface based on a crosshair effect corresponding to the fifth operation stage, the fifth operation stage being any one of the N charge stages and the second operation stage.

10. The method according to claim 1, further comprising:
skipping, in response to the shooting charge operation being in a sixth operation stage and a phase ending operation performed in parallel with the shooting charge operation being received, the sixth operation stage of the shooting charge operation and starting a seventh operation stage of the shooting charge operation, the sixth operation stage being any one of the N charge stages, and the seventh operation stage being a phase that is in the N charge stages and the second operation stage and that is after the sixth operation stage.

11. The method according to claim 10, wherein skipping the sixth operation stage of the shooting charge operation and starting the seventh operation stage of the shooting charge operation comprises:
skipping, in response to a duration of the shooting charge operation in the sixth operation stage reaching a duration threshold and the phase ending operation being received, the sixth operation stage of the shooting charge operation, and starting the seventh operation stage of the shooting charge operation.

12. The method according to claim 1, wherein the N charge stages and the second operation stage each comprise a plurality of timing nodes, and
the method further comprises:
transmitting, before the shooting charge operation is converted into the shooting operation, a state query request to a scene server of the virtual scene each time an elapsed duration of the shooting charge operation reaches one timing node, the state query request comprising the elapsed duration; and
receiving a state query response returned by the scene server, the state query response comprising a charging state corresponding to an eighth operation stage the shooting charge operation is in, the eighth operation stage being one of the N charge stages and the second operation stage;
applying the buff corresponding to the first operation stage to the virtual projectile launched by the virtual shooting prop comprises:
applying, in response to the shooting charge operation being converted into the shooting operation and the charging state in the state query response received last time being a charging state corresponding to the first operation stage, the buff corresponding to the first operation stage to the virtual projectile; and
applying the buffs corresponding to the N charge stages to the virtual projectile comprises:
applying, in response to the shooting charge operation being converted into the shooting operation and the charging state in the state query response received last time being a charging state corresponding to the second operation stage, the buffs respectively corresponding to the N charge stages to the virtual projectile.

13. A computer device, comprising one or more processors and a memory containing at least one computer instruction that, when being executed, causes the one or more processors to perform:
displaying a scene interface of a virtual scene, the virtual scene comprising a first virtual object, the first virtual object being equipped with a virtual shooting prop;
receiving a shooting charge operation triggered for the virtual shooting prop, the shooting charge operation having N charge stages, and N being an integer greater than or equal to 2;
applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and
applying, in response to the shooting charge operation being converted into the shooting operation in a second operation stage, the buffs corresponding to the N charge stages to the virtual projectile, the second operation stage being after the N charge stages.

14. The device according to claim 13, wherein the buff corresponding to a charge stage of the N charge stages comprises at least one of following:
an attribute change value generated by the virtual projectile increases;
a spread range of the virtual projectile decreases;
a collision range of the virtual projectile increases;
a flight speed of the virtual projectile increases; or
a ballistic trajectory of the virtual projectile changes.

15. The device according to claim 14, wherein in response to the buff comprising that the attribute change value generated by the virtual projectile increases, the attribute change value is positively correlated with a duration of the shooting charge operation in the charge stage corresponding to the buff.

16. The device according to claim 14, wherein in response to the buff comprising that the spread range of the virtual projectile decreases, the spread range is negatively correlated with the duration of the shooting charge operation in the charge stage corresponding to the buff.

17. The device according to claim 14, wherein in response to the buff comprising that the collision range of the virtual projectile increases, the collision range is positively correlated with the duration of the shooting charge operation in the charge stage corresponding to the buff.

18. The device according to claim 14, wherein in response to the buff comprising that the flight speed of the virtual projectile increases, the flight speed is positively correlated with the duration of the shooting charge operation in the charge stage corresponding to the buff.

19. The device according to claim 13, wherein the one or more processors are further configured to perform:
applying, in response to the shooting charge operation proceeding to a third operation stage, a first special effect corresponding to the third operation stage to the virtual projectile, the third operation stage being any one of the N charge stages and the second operation stage.

20. A non-transitory computer readable storage medium containing at least one computer instruction that, when being executed, causes at least one processor to perform:
displaying a scene interface of a virtual scene, the virtual scene comprising a first virtual object, the first virtual object being equipped with a virtual shooting prop;
receiving a shooting charge operation triggered for the virtual shooting prop, the shooting charge operation having N charge stages, and N being an integer greater than or equal to 2;
applying, in response to the shooting charge operation being converted into a shooting operation in a first operation stage, a buff corresponding to the first operation stage to a virtual projectile launched by the virtual shooting prop, the first operation stage being one of the N charge stages, and each of the N charge stages corresponding to a different buff effect; and
applying, in response to the shooting charge operation being converted into the shooting operation in a second operation stage, the buffs corresponding to the N charge stages to the virtual projectile, the second operation stage being after the N charge stages.
